(19) United States
(12) Patent Application Publication
(10) Pub. No.: US 2003/0197123 A1
(43) Pub. Date: Oct. 23, 2003

(54) Micromachined microprobe

(76) Inventors: Thomas Owen Mitchell, Redwood City, CA (US); Charles E. Bryson III, Santa Clara, CA (US); Andreas Berghaus, San Francisco, CA (US); Vahe Sarkissian, Saratoga, CA (US)

Correspondence Address: MICHAEL O. SCHEINBERG, P.O. BOX 164140, AUSTIN, TX, 78716-4140, US

(21) Appl. No.: 10/411,586

(22) Filed: Apr. 10, 2003

Related U.S. Application Data
(63) Continuation of application No. 09/354,528, filed on Jul. 15, 1999, now abandoned.

(51) Int. Cl. G12B 1/02

(52) U.S. Cl. 250/306; 73/105

(57) ABSTRACT

A probe having a probe tip, especially for use in an atomic force microscope, formed by micromachining techniques in a silicon wafer. The tip is photolithographically defined in a layer, preferably of silicon nitride deposited on the silicon wafer, and has a width and thickness of usually less than 250 nm. Thereby, the probe tip can be formed to have a generally square cross section in which one lateral dimension is determined by the layer thickness, and the other lateral dimension by the photolithography or by a subsequent step of focused ion beam milling. The portion of the silicon wafer underlying the area probe tip is etched away, preferably before the probe tip is etched, but another portion of the silicon is left to serve as a support at the base of the probe tip. A hinge may be formed in the silicon wafer, and the probe tip together with a robust shank can be made to rotate to a direction perpendicular to the wafer surface.

This application is a continuation of U.S. patent application Ser. No. 09/354,528, filed Jul. 15, 1999, which is hereby incorporated by reference.

### TECHNICAL FIELD OF THE INVENTION

The invention relates generally to scanning profilometers. In particular, the invention relates to probes for such profilometers fabricated by micromachining techniques.

### BACKGROUND AND SUMMARY OF THE INVENTION

In semiconductor fabrication and related technologies, it has become necessary to routinely determine critical dimensions (CD), in either the vertical or horizontal direction, of physical features formed in substrates. An example, shown in the illustrative cross sectional view of FIG. 1, includes a trench 10 formed in a substrate 12, the depth of the trench 10 being greatly exaggerated with respect to the thickness of a silicon wafer 12. In advanced silicon technology, an exemplary width of the trench is 0.18 μm, and its depth is 0.7 μm. The critical dimension of the trench 10 may be the width of the top of the trench opening or may be the width of the bottom of trench 10. In other situations, the depth of the trench 10 is an important dimension. For the dimensions described above, the trench 10 has a high aspect ratio of greater than 4. Although in typical designs, sidewalls 14 of the trench 10 have ideal vertical profile angles of 90°, in fact the profile angle may be substantially less. Much effort has been expended in keeping the profile angle at greater than 85° or even 88° to 90°, but it requires constant monitoring of the system performance to guarantee that so sharp a trench is etched. As a result, it has become necessary, either in the development laboratory or on the production line, to measure the profile of the trench 10 with horizontal resolutions of 0.18 μm and less. Depending upon the situation, the entire profile needs to be determined, particularly the sidewall angle, or the top or bottom trench width needs to be measured. More circular apertures, such as needed for inter-level vias, also need similar measurements. Similar requirements extend to measuring the profiles of vertically convex features such as interconnects.

To satisfy these requirements, profilometers based upon atomic force microscopy (AFM) and similar technology have been developed which rely upon the vertical position of a probe tip 20, illustrated in FIG. 1. Lee et al. describe in UK Patent Application 2,009,409-A, published Jun. 13, 1979, a jumping mode of operation involving a raster scan in which the probe tip 20 is continuously scanned in a horizontal direction while the probe tip 20 is being gradually lowered until it strikes the surface and is thereafter raised to a fixed height before being lowered again. Thereby, multiple height determinations are made along a scan line. Then, another line is scanned to enable imaging of the topography in two dimensions. Alternatively, in a pixel scan, the probe tip 20 is horizontally positioned over the feature to be probed, and then the probe tip 20 is gently lowered until it is stopped by an edge of the feature, preferably the top surface, and circuitry to be briefly described later then measures the height at which the probe tip stops. The probe tip 20 is then withdrawn to a height above any intervening features before the tip 20 is moved to the next position to be probed.

An example of such a critical dimension measurement tool is the Model 3010 available from Surface/Interface, Inc. of Sunnyvale, Calif. It employs technology similar to the rocking balanced beam probe disclosed by Griffith et al. in U.S. Pat. No. 5,307,693 and by Bryson et al. in U.S. Pat. No. 5,756,887. It is intended to be used in the pixel mode in which the probe is discontinuously scanned along a line. At a large number of discrete points, the lateral motion is stopped, and the probe is lowered until it encounters the surface being profiled. The tool is schematically illustrated in the side view of FIG. 2. A wafer 30 or other sample is supported on a support surface 32 supported successively on a tilt stage 34, an x-slide 36, and a y-slide 38, all of which are movable along their respective axes so as to provide horizontal two-dimensional and tilt control of the wafer 30. Although these mechanical stages provide a relatively great range of motion, their resolutions are relatively coarse compared to the resolution sought in the probing. The bottom y-slide 38 rests on a heavy granite slab 40 providing vibrational stability. A gantry 42 is supported on the granite slab 40. A probe head 44 hangs in the vertical z-direction from the gantry 42 through an intermediate piezoelectric actuator providing about 10 μm of motion in (x, y, z) by voltages applied across electrodes attached to the walls of a piezoelectric tube. A probe 46 with tiny attached probe tip 20 projects downwardly from the probe head 44 to selectively engage the probe tip 20 with the top surface of the wafer 30 and to thereby determine its vertical and horizontal dimensions.

Principal parts of the probe head 44 of FIG. 2 are illustrated in orthogonally arranged side views in FIGS. 3 and 4. A dielectric support 50 fixed to the bottom of the piezoelectric actuator 45 includes on its top side, with respect to the view of FIG. 2, a magnet 52. On the bottom of the dielectric support 50 are deposited two isolated capacitor plates 54, 56 and two interconnected contact pads 58.

A beam 60 is medially fixed on its two lateral sides and is also electrically connected to two metallic and ferromagnetic ball bearings 62, 64. The beam 60 is preferably composed of heavily doped silicon so as to be electrically conductive, and a thin silver layer is deposited on it to make good electrical contacts to the ball bearings. However, the structure may be more complex as long as the upper surface of the beam 60 is electrically conductive in the areas of the ball bearings 62, 64 and of the capacitor plates 54, 56. The ball bearings 62, 64 are placed on the contact pads 58 and generally between the capacitor plates 54, 56, and the magnet 52 holds the ferromagnetic bearings 62, 64 and the attached beam 50 to the dielectric support 50. The attached beam 60 is held in a position generally parallel to the dielectric support 50 with a balanced vertical gap of about 25 μm between the capacitor plates 54, 56 and the beam 60. Unbalancing of the vertical gap allows a rocking motion of about 25 μm. The beam 60 holds on its distal end a glass tab 70 to which is fixed a stylus 72 having the probe tip 20 projecting downwardly to selectively engage the top of the wafer 12 being probed. An unillustrated dummy stylus or substitute weight on the other end of the beam 60 may provide rough mechanical balancing of the beam in the neutral position.

Two capacitors are formed between the respective capacitor plates 54, 56 and the conductive beam 60. The capacitor plates 54, 56 and the contact pads 58, commonly electrically connected to the conductive beam 60, are separately connected by three unillustrated electrical lines to three terminals of external measurement and control circuitry. This servo system both measures the two capacitances and applies differential voltage to the two capacitor plates 54, 56 to keep them in the balanced position. When the piezoelectric actuator 45 lowers the stylus 72 to the point that it encounters the feature being probed, the beam 60 rocks upon contact of the stylus 72 with the wafer 30. The difference in capacitance between the plates 54, 56 is detected, and the servo circuit attempts to rebalance the beam 60 by applying different voltages across the two capacitors, which amounts to a net force that the stylus 72 is applying to the wafer 30. When the force exceeds a threshold, the vertical position of the piezoelectric actuator 45 is used as an indication of the depth or height of the feature.

Conventionally, the probe 20 of FIG. 1 has a conically shaped probe tip 74 with sloped walls 76 generally forming a doubled apex angle 2α substantially greater than 0°. That is, the probe tip 20 has an acutely shaped tip 74 but with finitely sloped sidewalls 76.

A difficulty arises if the apex angle of α of the probe tip 74 is too large to allow the probe to test the sidewall angle of the trench 10 or, as illustrated in FIG. 1, to even reach the bottom comers 78 of the trench 10. In very general terms, if the angle α is greater than the sidewall slope, then the probe 20 is incapable of measuring the sidewall 14 and cannot accurately measure the width of the trench bottom. Of course, in the case that the sidewall profile varies from its top to bottom, whatever part has an angle less than that of the probe tip 20 cannot be measured. Efforts have been made to make cylindrical microprobes from optical fibers, see for example U.S. Pat. Nos. 5,676,852 and 5,703,979 to Filas et al. However, this technique does not reliably produce the smaller diameters required for probing a 180 nm trench.

A further problem with the conventional probe tip manufactured from silica optical fiber is that the very narrow portions are subject to significant deflection when they are subjected to a lateral force, for example, when the lowering probe tip encounters the sloping trench sidewall. The deflection reduces the vertical measurement accuracy and also renders suspect the horizontal position of the blocking feature, as measured by both the vertical and horizontal positions of the piezoelectric actuator 45.

### SUMMARY OF THE INVENTION

The invention may be summarized as a probe tip manufactured by micromachining techniques derived from the fabrication of silicon integrated circuits. For example, a layer of a non-silicon material is deposited over a silicon wafer to the thickness of the desired probe width. Silicon nitride is the preferred material of the deposited layers. Photolithographic techniques are used to form in the deposited layer both a probe tip having a width generally corresponding to desired probe width as well as a larger support structure at the proximal end of the probe tip. The portion of the backside of the silicon wafer underlying the probe tip is etched away to provide a cantilevered probe tip, which may be attached to the wafer in the support area. The wafer is diced around the support area to leave a free-standing probe tip and integral support. By this method, many probes may be simultaneously formed on the wafer.

The probe tip may be attached to the wafer through a hinge. After the formation of the probe tip, it is rotated about the hinge to project above the plane of the wafer. Part of the wafer serves as a support structure that is easily handled.

### BRIEF DESCRIPTION OF THE DRAWINGS

FIG. 1 is a schematic cross-sectional view of a instrument for measuring critical dimensions in a silicon wafer.

FIG. 2 is a side view of a commercially available system for measuring critical dimensions.

FIGS. 3 and 4 are orthogonal side views of the probe head of the system of FIG. 2.

FIG. 5 is a cross-sectional view of a silicon wafer with the probe layer deposited but not laterally defined.

FIG. 6 is a cross-sectional view of the wafer of FIG. 5 with the probe layer etched into its final form.

FIG. 7 is a plan view of the wafer of FIG. 6.

FIG. 8 is a side cross-sectional view of the wafer of FIGS. 5 and 6 after the backside of the wafer has been selectively etched away.

FIG. 9 is an end elevational view of the probe after its separation from the growth wafer.

FIG. 10 is an orthographic view of the probe of FIG. 9.

FIG. 11 is a cross-sectional view of a wafer being probed by the probe tip of the invention.

FIG. 12 is a plan view of a wafer being fabricated with a large number of probes.

FIGS. 13 and 14 are respectively side elevational and plan views of a hinged probe assembly utilizing a hinge, the views being taken at the termination of micromachining and dicing.

FIGS. 15 and 16 are respectively side elevational and plan views of the probe of FIGS. 13 and 14 after the probe tip has been rotated into its operational position.

FIG. 17 is an elevational side view of the probe after the hinged probe has been immobilized in its operational position.

### DETAILED DESCRIPTION OF PREFERRED EMBODIMENTS

In recent years micromachining has been developed to fabricate micro electro-mechanical systems (MEMS) using techniques well developed in the fabrication of silicon integrated circuits. Review articles include Kovacs et al., “Bulk Micromachining of Silicon,” Proceedings of the IEEE, vol. 6, 86, vo. 8, August, 1998, pp. 1536-1551. Micromachining can be advantageously applied to fabricate a mechanical probe tip integrated with a support, as has been disclosed by Albrecht et al. in “Microfabrication of cantilever styli for the atomic force Microscope,” Journal of Vacuum Science and Technology A, vol. 8, no. 4, 1990, pp. 3386-3395, by Boisen et al. in “AFM probes with directly fabricated tips,” Journal of Micromechanics and Microengineering, vol. 6, 1996, pp. 58-62, and by Tortonese in “Cantilevers and Tips for Atomic Force Microscopy,” IEEE Engineering in Medicine and Biology, March/April 1997, pp. 28-33. Most of these microprobes have involved V-shaped cantilevered layers or pyramids projecting from a cantilevered layer. Albrecht et al. briefly discuss rectangular cantilevers but ones having a minimum width of 5 μm, a minimum thickness of 0.4 μm, and a minimum length of 100 μm. These dimensions should be compared to a typical wafer thickness of 500 μm. Albrecht et al. then suggest using a corner of a cantilever as a tip. Thus, their dimensions are incompatible with probing trenches and vias in integrated circuits.

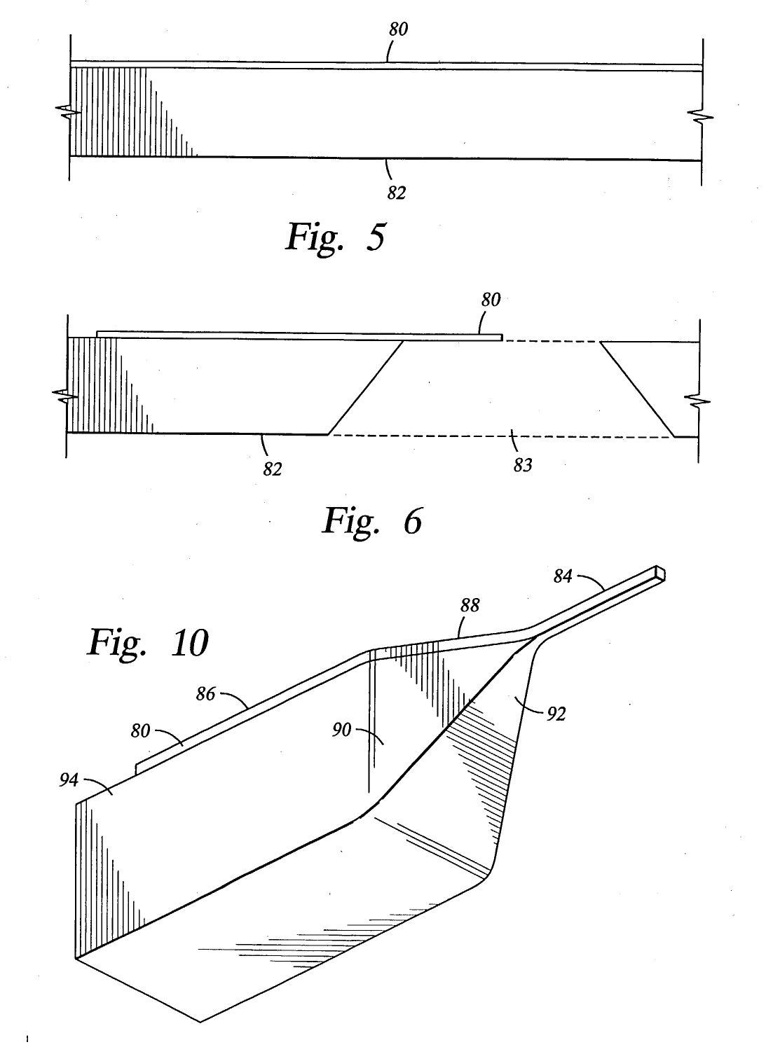

In one embodiment of the invention, as illustrated in the cross-sectional view of FIG. 5, a probe layer 80 is deposited over a crystalline silicon wafer 82. For some types of micromachining the surface orientation of the silicon and the orientation of the probe relative to silicon crystalline axes are important. The wafer may be of standard thickness, but may be somewhat thinner, for example, 200 μm. Other materials than silicon may be used for the substrate, and a thick layer of another material may be deposited on the substrate and then etched away to leave a relatively thick support layer. However, a silicon wafer support is preferred.

The thickness of the probe layer 80 equals the desired width of the probe, for example, 160 nm. The material of the probe layer 80 must be strong and be differentially etchable with respect to silicon. Examples of the material are silica (SiO₂), silicon nitride (Si₃N₄), and titanium nitride (TiN). All these materials are commonly grown to the thicknesses desired of the probe tip. Silica can be thermally oxidized from silicon or preferably is deposited by plasma-enhanced chemical vapor deposition (PECVD) using tetraethyorthosilicate (TEOS) as a precursor gas. Silicon nitride can be grown by PECVD using silane (SiH₄) and nitrogen (N₂) as precursors. Titanium nitride is usually formed by reactive sputtering of a titanium target in a nitrogen plasma, although CVD techniques are available. Some of these materials can be deposited in thin layers by other methods such as sol-gel.

Yet other materials may be chosen for the probe layer, including sapphire, silicon carbide, and diamond. However, we believe that silicon nitride is the preferred easily available material. It is known that the deflection for a circular probe tip of radius R and length L fixed and one end and subjected to a lateral force F at its other end is given by the equation

$$x = \frac{4 {FL}^{3}}{3 π {YR}^{4}}$$

where Y is Young's modulus. The relationship for a square probe would be nearly the same. TABLE 1 gives approximate values of Young's modulus for a number of common materials amenable to MEMS fabrication.

TABLE 1

| | Young's Modulus |
|---|---|
| | (GPa) |
| Fused Silica | 73.2 |
| Silicon | 170 |
| Polysilicon | 169 |
| Silicon Nitride | 270 |
| Sapphire | 345 |
| Silicon Carbide | 466 |
| Diamond | 1000 |

Of these materials, silicon nitride is the material having the highest Young's modulus and which can be easily integrated into conventional silicon processing. Silicon nitride affords a nearly four-fold increase in Young's modulus over the silica used in the prior art microprobes. The technology of depositing and etching silicon nitride is very well known.

After the silicon nitride layer 80 has been deposited on the front side of the wafer, a well 83, illustrated in the cross-sectional view of FIG. 6, is photolithographically defined in the backside of the wafer to underlie the intended probe tip. The well 83 corresponds to the aperture 102 to be described later with reference to FIG. 12. The well 83 is etched all the way through the silicon wafer 82, but the as yet laterally undefined silicon nitride layer 80 acts as an etch stop so that a thin silicon nitride membrane remains over the well 83, as viewed from the front side, after the etching.

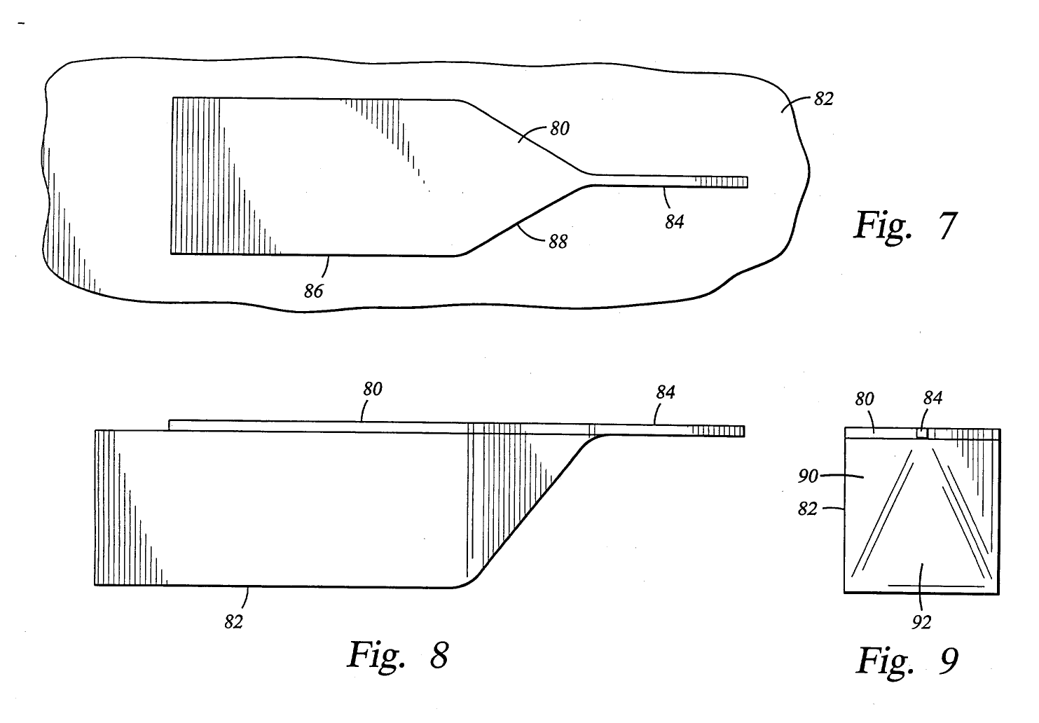

The processing then returns to the front side. As illustrated in the cross-sectional view of FIG. 6 and the plan view of FIG. 7, the probe layer 80 is patterned and etched in a photolithographic process well known in the fabrication of silicon integrated circuits to leave a probe pattern of a long, narrow probe tip 84 overlying the well 83, a wide support section 86, and a taper section 88 joining the probe tip 84 and the support section 86. The probe tip 84 is aligned to overlie the backside well 83, and the taper section 88 is aligned to overlie sloping sidewalls of the well 83. Exemplary dimensions are a length of 1.51 μm for the probe tip 84, a length of 1 mm for the taper section 88, a length of 5 mm and a width of 200 μm for the support section 86. The etching of the probe pattern can be performed by plasma etching after development of a photoresist mask.

The nitride etching produces the structure illustrated in the cross-sectional view of FIG. 8. Sloped walls 90, 92, best illustrated in the isometric view of FIG. 10, in the silicon wafer 82 may be formed during the well etching by the known characteristics of some wet etchants such as KOH to leave exposed oriented planes in silicon, as disclosed by Petersen in “Silicon as a Mechanical Material,” Proceeding of the IEEE, vol. 70, no. 5, May 1982, pp. 420-457. This leaves a free-standing, generally square probe tip 84 having side dimensions of about 160 nm and extending about 1.5 μm. The fabrication of a similar structure is disclosed by Boisen et al. and by Kovacs et al. in the previously cited articles.

The width of the probe tip 84 may be determined by the single-step photolithography of the nitride layer 80. Widths of 150 nm are achievable with electron-beam lithography. However, e-beam definition of photoresist is an expensive process. Alternatively, a significantly wider probe tip, for example, of 500 nm, may be easily defined by conventional lithography. This width can then be reduced by milling the lateral sides of the wide tip with a focused ion beam (FIB). An FIB milling machine produces a very narrow (7 nm) beam of, for example, gallium ions which can mill sharp, 5 nm edges. Automated FIB machines have been developed for milling of recorder heads, and are commercially available from FEI Company of Hillsboro, Oreg. Similar milling can be used to reduce the thickness of the tip, originally defined by the thickness of the probe layer 80. Selective milling of the thickness or any other dimensional aspect of different probe tips from a single wafer, either prior to or after dicing or sawing, allows tips of different widths, thickness, and/or tip orientations to be fabricated from the same wafer fabricated with a single set of photolithographic masks starting from a uniform thickness of the probe layer 80.

The silicon wafer 82 is then diced or sawed in areas away from the probe tip 84 to form a macroscopic support 94, as illustrated in FIG. 10, which can handled relatively easily. The sloped walls 90, 92 form a skewed pyramidal structure linking the macroscopic support 94 and the microscopic probe tip 84. The rectangular support 94 extends from the base of the pyramid, and the probe tip 84 extends from the apex of the pyramid. The pyramid structure in combination with the tapered portion 88 of the probe layer 80 also allows access to small surface features in the wafer being probed.

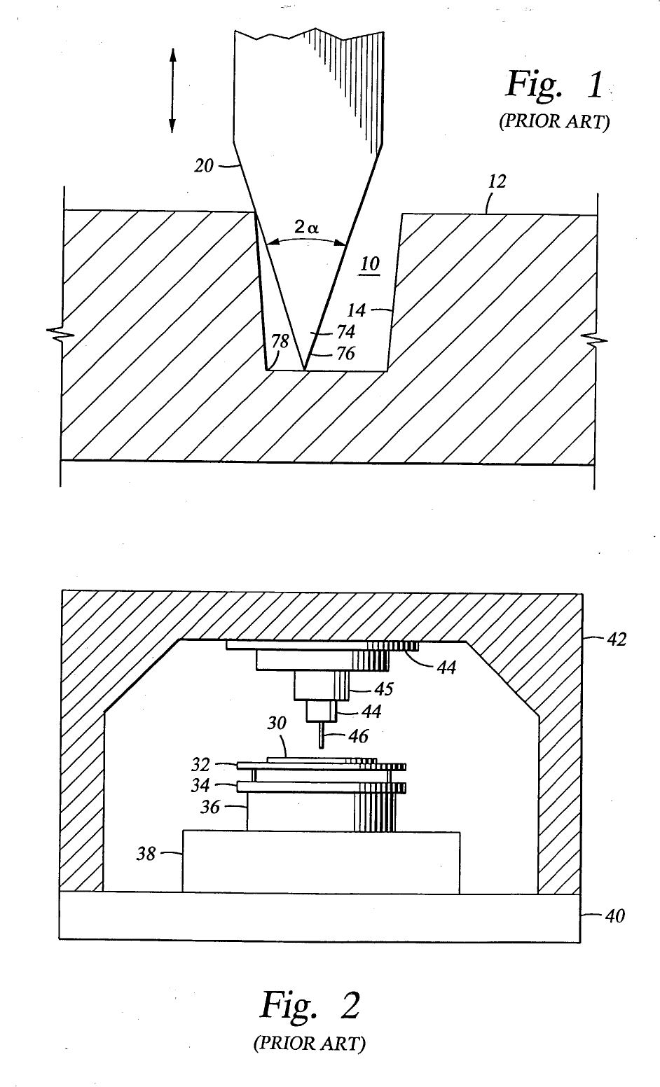

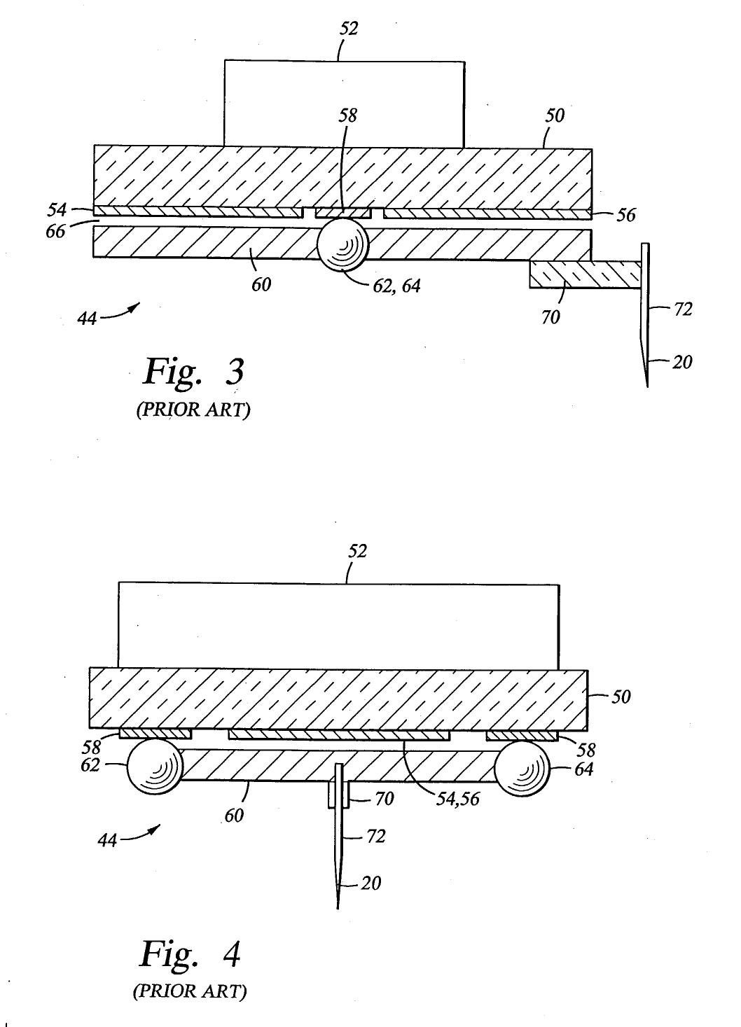

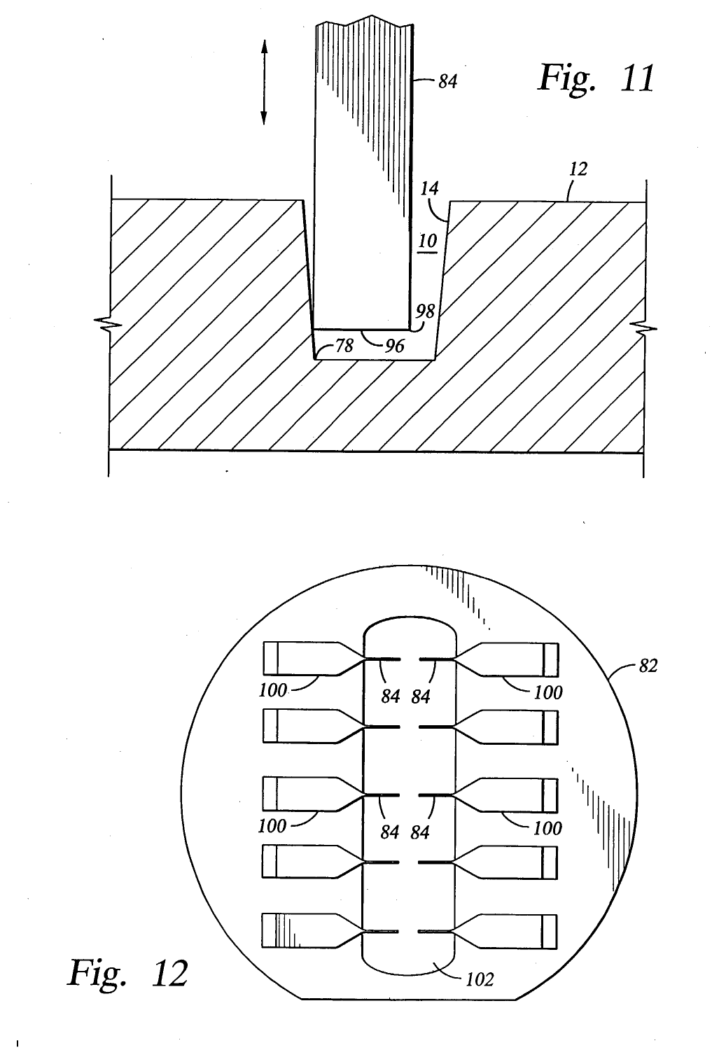

The thick support 94 is then fixed to the tab 70 of FIG. 3, similarly to how the prior-art probe 72 of FIG. 3 is attached, with the square probe tip 84 of the invention projecting downwardly. As shown in FIG. 11, the generally square probe tip 84 having a width of 150 nm is smaller than the currently researched trench widths of 180 nm. As a result, its tip 84 can fit within the trench 10 all the way to its bottom as long as the bottom trench width is at least 150 nm. Furthermore, because the square probe tip 84 has a flat bottom 96 with approximately perpendicular comers 98 and vertical probe sidewalls, it becomes possible for the probe tip 84 to engage and therefore sense the trench side wall 14, thereby providing a more accurate profile of the trench 10. Of course, the fabrication process may round off the bottom comers somewhat, but the horizontal resolution afforded by the generally rod-like probe 84 of FIG. 11 on a sharply sloping sidewall 14 is nonetheless greater than that afforded by the conical probe 20 of FIG. 1. Further, the fabrication process may also round off the side comers of the probe 84 so that it more resembles a cylindrical rod. Nonetheless, such a cylindrically shaped probe still affords the advantages described above. It is to be further appreciated that the two transverse dimension of the probe tip 84 need not be equal providing a square shape. A more rectangular shape is acceptable as long as it can be assured that the small dimension of a narrow trench being probed is aligned with the short dimension of the probe tip 84.

The probe tip produced by the invention is much smaller than any rectangular tip known in the prior art, having a minimum lateral dimension in at least one direction of less than 1 μm, preferably less than 250 nm. For probing via holes, both lateral dimensions should be less than 250 nm. Structural integrity can be maintained by a combination of keeping the length of the probe tip relatively short, for example, less than 5 μm, while the pyramidal transition between the probe tip and the silicon support reduces problems of positioning a bulk structure within micrometers of the structure being probed. The relatively short probe length allowed by the pyramidal structure also allows a greatly increased resonant frequency for the probe and produces a stiff probe tip despite its very small cross section.

A significant advantage of micromachined probe tips is that they can be manufactured in large quantities with relatively little additional processing and labor involved for multiple probe tips over what is required for one. As illustrated in the plan view of FIG. 12, a large number of probe shapes 100 are etched into the probe layer 80 overlying the silicon wafer 82. The probe shapes 100 are arranged in opposed columns with the probe tips 84 of the two columns facing each other. A single aperture 102 corresponding to the well 83 of FIG. 6 is etched through the backside of the wafer 82. Of course, depending upon the relative sizes of the probes and the wafer, a larger number of probes may be formed in each column, and additional pairs of columns may be formed in parallel with the shapes 100 of the different columns being aligned to allow common dicing. Up to the point in processing illustrated in FIG. 12, it matters little economically how many probe shapes 100 are formed on the wafer. A hundred can be as easily formed as one. Subsequently, the individual probe shapes 100 are separated by dicing in the two dimensions, whether by cleaving or sawing.

Although the embodiment described above uses a silicon nitride probe layer deposited on a silicon wafer, other material combinations are possible. Furthermore, the probe layer may be bonded to a substrate, for example, by atomic bonding or fusion bonding. It is possible to bond a relatively thick free-standing probe layer to the substrate and then to thin the probe layer by, for example, chemical mechanical polishing (CMP). Alternatively, the probe layer may be thermally grown, for example, by oxidation or nitridation of silicon.

The fabrication methods of the invention allow a tiny probe tip to be defined with one horizontal dimension defined by the thickness of a deposited or otherwise bonded planar layer and another horizontal dimension defined by lithography and perhaps by further ion milling. Furthermore, the fabrication techniques are amenable to economies attained in simultaneous processing of multiple tips.

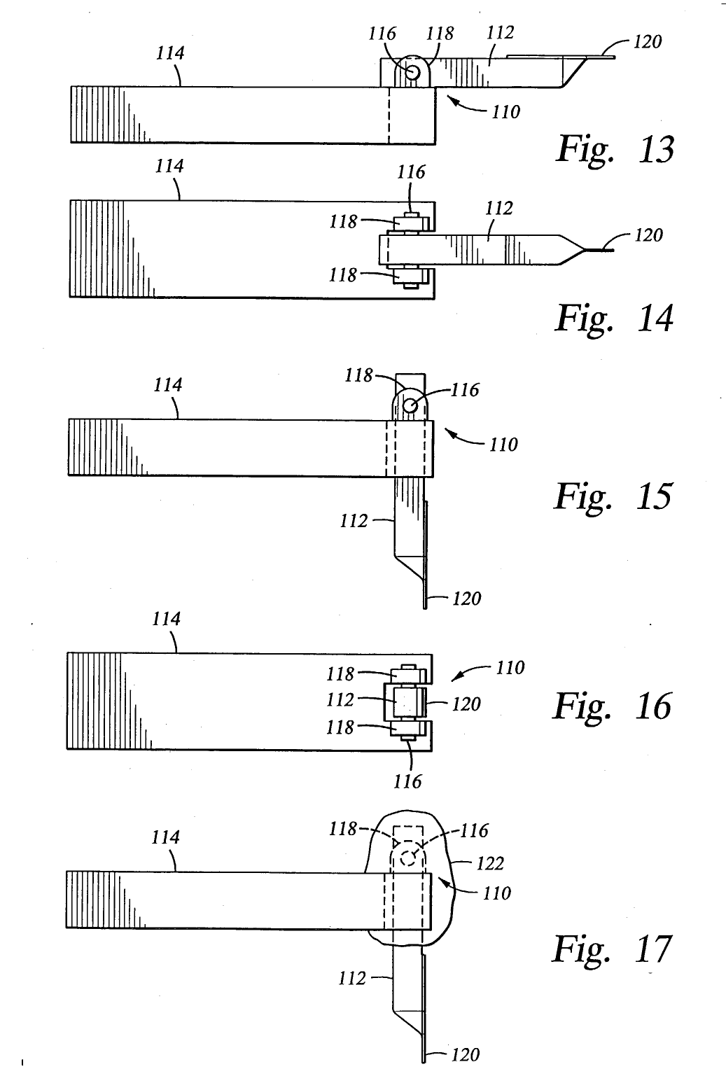

Additional labor can be saved if the probe is integrated with the tab through means of a rotatable probe tip. As illustrated in the side elevational and plan views respectively of FIGS. 13 and 14, micromachining techniques are used to form a cantilevered hinge 110, as disclosed by Wu in “Micromachining for Optical and Optoelectronic Systems,” Proceedings of the IEEE, vol. 85, no. 11, November 1997, pp. 1833-1855. A hinge shank 112 is formed of a separate layer deposited on a substrate 114. The hinge shank 112 at some point is separated from the substrate 114. The hinge 110 is formed between the hinge shank 112 and the substrate 114 including hinge pins 116 supported by two hinge posts 118. Over the probe shank 112 is formed a probe tip 120 of similar structure and fabrication to that previously described.

As before, a large number of such probe assemblies may be fabricated in common on a single substrate. After the probe assemblies have been diced from each other, the hinge 110, as illustrated in the side elevational and plan views respectively of FIGS. 15 and 16, is swung downwardly so that its probe tip 120 extends perpendicularly away from the plane of the substrate 114. Finally, as shown in the side elevational view of FIG. 17, a glob 122 of epoxy or other adhesive is applied to the area of the hinge joint to immobilize the hinge 110 and attached probe tip 120 pointing in the perpendicular direction.

The substrate 114 replaces the tab 70 and is directly attached to the beam 60 of FIGS. 3 and 4. Thereby, the tedious labor and failure-prone process of attaching the probe tip to the tab is replaced by the relatively simple and non-precise application of the epoxy.

Although the inventive probe has been described with reference to a rocking-beam atomic force microscope operating in the pixel sampling mode, it can be used in a jumping-mode AFM with other probes and profilometers requiring a very small probe tip.

The invention thus provides a very small probe tip but one that is relatively inexpensive to fabricate at high yields.

We claim as follows:

1. A method of fabricating a probe for interacting with a sample, comprising the steps of:
forming a layer of a material over a substrate;
removing a portion of said substrate such that a first portion of said layer of material has no underlying substrate and a second portion of said layer of material has an underlying substrate; and
forming a probe tip from part of said first portion, the probe tip having a distal end having a substantially uniform cross section and the probe tip having a thickness, a width, and a length, such that both said probe tip thickness and said probe tip width are substantially smaller than said probe tip length.

2. The method of claim 1, wherein forming a probe tip from part of said first portion includes etching said first portion with a focused ion beam.

3. The method of claim 1, wherein forming a probe tip from part of said first portion includes thinning the first material using a focused ion beam.

4. The method of claim 1, wherein forming a probe tip from part of said first portion comprises etching said first portion with a charged particle beam.

5. The method of claim 1, wherein forming a probe tip from part of said first portion includes forming a probe tip that is coplanar with the second portion.

6. The method of claim 1 further comprising etching said second portion and underlying substrate to form a support, said support having a width substantially larger than said probe tip width.

7. The method of claim 1, wherein said probe tip thickness and said probe tip width are less than 250 nm.

8. The method of claim 1, wherein removing a portion of said substrate such that a first portion of said layer of material has no underlying substrate and a second portion of said layer of material has an underlying substrate includes forming from the substrate a support tapering toward the distal end of the probe tip.

9. The method of claim 1, further comprising:
forming one or more additional probe tips from said first portion of said layer of material;
forming supports for each of the probe tips from said second portion and underlying substrate; and
separating each probe tips and corresponding support from the other probe tips and supports, thereby producing multiple probes.

10. The method of claim 1, wherein forming a probe tip from part of said first portion comprises:
forming a first probe tip shape using a lithography process; and
milling said first probe tip shape with a charged particle beam to produce a second probe tip shape.

11. A probe formed by the method of claim 1.

12. A method of forming a probe for interacting with a sample, comprising the steps of:
depositing a layer of a material over a substrate;
substantially removing the substrate underlying a first portion of said layer; and
machining said first portion of said layer to form a probe tip.

13. The method of claim 12, wherein machining said first portion of said layer to form a probe tip includes machining said first portion using a charged particle beam.

14. The method of claim 13, wherein machining said first portion of said layer to form a probe tip includes machining said first portion using a focused ion beam.

15. The method of claim 12, wherein machining said first portion comprises:
forming a first probe tip shape using a lithography process; and
milling said first probe tip shape with a charged particle beam to produce a second probe tip shape.

16. The method of claim 15 wherein milling said first probe tip shape with a charged particle beam includes milling said first probe tip shape using a focused ion beam.

17. The method of claim 12, wherein machining said first portion of said layer to form a probe tip comprises forming a probe tip having a distal end having a substantially uniform cross section.

18. A probe formed in accordance with the method of claim 17.

19. The method of claim 12, wherein machining said first portion of said layer to form a probe tip comprises forming a probe tip having a distal end having a substantially rectangular cross section.

20. A probe formed in accordance with the method of claim 19.

21. The method of claim 12, wherein said substrate comprises silicon or quartz.

22. The method of claim 12, wherein said layer of material comprises silica, silicon nitride, titanium nitride, sapphire, silicon carbide, or diamond.

23. The method of claim 12, wherein said substrate comprises silicon and said layer of material comprises silicon nitride.

24. The method of claim 12, wherein machining a probe tip into said first portion of said layer comprises machining a probe tip into said first portion of said layer to form a probe tip with a minimum lateral dimension of less than 250 nm.

25. A probe formed by the method of claim 12.

26. A probe for an atomic force microscope, comprising a probe tip portion of a first material, the probe tip portion having a having a substantially uniform cross section towards its distal end, the substantially uniform cross section having a width and thickness less than 250 nm; and
a support portion supporting the probe tip.

27. The probe of claim 26, wherein the support potion comprises a second material.

28. The probe of claim 27 further comprising a probe tip extension portion of said first material extending from the probe tip portion, the probe tip extension portion having a width substantially greater than that of the probe tip portion and wherein the support portion underlies a portion of the probe tip extension portion.

29. The probe of claim 27 in which the support portion tapers under the probe tip extension portion towards the probe tip portion.
